(19) United States
(12) Patent Application Publication
(10) Pub. No.: US 2013/0346959 A1
(43) Pub. Date: Dec. 26, 2013

(54) TERMINAL MANAGING SERVER DEVICE, TERMINAL DEVICE, AND TERMINAL MANAGING METHOD

(71) Applicant: PANASONIC CORPORATION, Osaka (JP)

(72) Inventor: Toshiyuki TANAKA, Osaka (JP)

(21) Appl. No.: 13/919,329

(22) Filed: Jun. 17, 2013

(30) Foreign Application Priority Data
Jun. 25, 2012 (JP) 2012-142465

(51) Int. Cl. G06F 9/445

(52) U.S. Cl. CPC G06F 8/65
USPC 717/170; 717/171

(57) ABSTRACT

A terminal managing server device for managing a terminal device which receives content, the terminal managing server device including: a storing unit which stores therein terminal information including information indicating a version of firmware of the terminal device; and a processing unit configured to selectively transmit to the terminal device one of (i) a first update request for updating the firmware by a first updating method and (ii) a second update request for updating the firmware by a second updating method in which update timing is different from update timing in the first updating method, based on the terminal information stored in the storing unit.

### CROSS REFERENCE TO RELATED APPLICATION

The present application is based on and claims priority of Japanese Patent Application No. 2012-142465 filed on Jun. 25, 2012. The entire disclosure of the above-identified application, including the specification, drawings and claims is incorporated herein by reference in its entirety.

### FIELD

The present disclosure relates to a terminal managing server device for managing a terminal device which receives content.

### BACKGROUND

Patent Literature (PTL) 1 discloses a content distribution method which enables real time content distribution in a dynamic manner. In the content distribution method, a system operation unit and plural nodes for receiving broadcast content are connected via a network, and the system operation unit distributes content according to an individual profile in each of the nodes. Thus, content according to each individual profile is distributed in real time in a dynamic manner.

### CITATION LIST

### Patent Literature

[PTL 1] Japanese Unexamined Patent Application Publication No. 2002-171507

### SUMMARY

### Technical Problem

The present disclosure provides a terminal managing server device which is capable of appropriately managing a terminal device which receives content.

### Solution to Problem

The terminal managing server device according to the present disclosure is a terminal managing server device for managing a terminal device which receives content, the terminal managing server device including: a storing unit which stores therein terminal information including information indicating a version of firmware of the terminal device; and a processing unit configured to selectively transmit to the terminal device one of (i) a first update request for updating the firmware by a first updating method and (ii) a second update request for updating the firmware by a second updating method in which update timing is different from update timing in the first updating method, based on the terminal information stored in the storing unit.

### Advantageous Effects

The terminal managing server device according to the present disclosure is capable of appropriately managing a terminal device which receives content.

### BRIEF DESCRIPTION OF DRAWINGS

These and other advantages and features of the disclosure will become apparent from the following description thereof taken in conjunction with the accompanying drawings that illustrate a specific embodiment of the present disclosure.

FIG. 1 is a block diagram showing a schematic configuration of a content receiving system according to an embodiment.

FIG. 2 is a block diagram showing a configuration of the content receiving device according to the embodiment.

FIG. 3A is a diagram showing an example of a menu screen.

FIG. 3B is a diagram showing an example of an item list of the menu screen.

FIG. 3C is a diagram for illustrating an example of menu items on the menu screen.

FIG. 4A is a diagram showing an exemplary description of a program (first half) for displaying the menu screen according to the embodiment.

FIG. 4B is a diagram showing an exemplary description of the program (latter half) for displaying the menu screen according to the embodiment.

FIG. 5A is a diagram showing an exemplary description of a menu item according to the embodiment.

FIG. 5B is a diagram showing an exemplary description of another menu item according to the embodiment.

FIG. 5C is a diagram showing an exemplary description of the item list according to the embodiment.

FIG. 6 is a block diagram showing a configuration of a first server according to the embodiment.

FIG. 7 is a flowchart showing operations for updating a screen constituent element according to the embodiment.

FIG. 8 is a flowchart showing operations for deleting the screen constituent element according to the embodiment.

FIG. 9 is a flowchart showing operations for updating firmware according to the embodiment.

FIG. 10 is a flowchart showing operations of the content receiving device in starting up according to the embodiment.

FIG. 11 is a flowchart showing operations of the first server when the screen constituent element is updated in the embodiment.

FIG. 12 is a diagram showing an example of the menu screen which is changed according to the update of the screen constituent element according to the embodiment.

FIG. 13 is a diagram showing an example of a terminal information DB according to the embodiment.

FIG. 14 is a flowchart showing operations when a new menu item is added to all terminal devices of a target model.

FIG. 15 is a flowchart showing operations when the number of menu items is changed according to an operation by a user.

FIG. 16 is a flowchart showing operations when the menu items themselves are updated.

FIG. 17 is a flowchart showing operations when a minimum required version of the firmware is changed.

FIG. 18 is a flowchart showing operations of the first server in transmitting a message (request) to the content receiving device.

FIG. 19 is a flowchart showing operations for determining a terminal to which an update request is transmitted and for transmitting the update request.

FIG. 20 is a block diagram showing a configuration of a server system according to a variation.

### DESCRIPTION OF EMBODIMENT

### Underlying Knowledge Forming Basis of the Present Disclosure

A content receiving device obtains, when starting up, screen constituent elements from a server which manages the screen constituent elements which are for displaying a menu screen in order to display the menu screen in an updated state. The content receiving device then displays the menu screen based on the screen constituent elements.

However, since the screen constituent elements are obtained from the server via a network, it takes time from the time when a user requests to start up the content receiving device to the time when the menu screen is displayed. Moreover, the content receiving device accesses the server every time even when the screen constituent elements in the server are not updated. Thus, a load of the server increases in proportion to an increase in the number of content receiving devices.

In view of the above, a terminal managing server device according to an aspect of the present disclosure is a terminal managing server device for managing a terminal device which receives content, the terminal managing server device including: a storing unit which stores therein terminal information including information indicating a version of firmware of the terminal device; and a processing unit configured to selectively transmit to the terminal device one of (i) a first update request for updating the firmware by a first updating method and (ii) a second update request for updating the firmware by a second updating method in which update timing is different from update timing in the first updating method, based on the terminal information stored in the storing unit.

With this, the terminal managing server device is capable of appropriately controlling timing to update the firmware of the terminal device. Therefore, the terminal managing server device is capable of appropriately managing the terminal device which receives the content.

For example, the terminal device may be a terminal device which receives content, the terminal device including: a message processing unit configured to receive one of (i) a first update request for updating firmware of the terminal device by a first updating method and (ii) a second update request for updating the firmware by a second updating method in which update timing is different from update timing in the first updating method; and a firmware updating unit configured to update the firmware, in which the firmware updating unit is configured to: update the firmware by the first updating method when the message processing unit receives the first update request; and update the firmware by the second updating method when the message processing unit receives the second update request.

With this, the terminal device is capable of updating the firmware at appropriate timing according to the first update request or the second update request.

Moreover, for example, the content receiving device (terminal device) may be a content receiving device which receives content and displays a menu screen in an updated state, the content receiving device includes: a message processing unit which receives, irrespective of whether the content receiving device is in an active state or in a non-active state, an update request for updating a screen constituent element which is for displaying the menu screen; a screen constituent element updating unit which obtains the screen constituent element when the message processing unit receives the update request while the content receiving device is in the active state or in the non-active state; a data updating unit which obtains, irrespective of whether the content receiving device is in the active state or in the non-active state, data used in the menu screen which is displayed based on the screen constituent element; a storing unit which stores therein the screen constituent element obtained by the screen constituent element updating unit and the data obtained by the data updating unit; and a screen rendering unit which renders, at a time when the content receiving device starts up, the menu screen using the screen constituent element obtained in advance by the screen constituent element updating unit and the data obtained in advance by the data updating unit.

With this, it is possible to shorten the time until the menu screen is displayed in an updated state when starting up the content receiving device.

Moreover, the message processing unit may further receive a deletion request for deleting the screen constituent element and the screen constituent element updating unit may delete the screen constituent element stored in the storing unit when the deletion request is received by the message processing unit.

Moreover, the screen constituent element updating unit may obtain the screen constituent element when the screen constituent element that is obtained in advance by the screen constituent element updating unit is not stored in the storing unit at the time when the content receiving device starts up, and the content receiving device may further include a firmware updating unit which updates the firmware when the screen constituent element obtained by the screen constituent element updating unit indicates an update of the firmware.

Moreover, the message processing unit may further receive an update request for updating the firmware, the screen constituent element updating unit may delete the screen constituent element stored in the storing unit when the update request is received by the message processing unit, and the content receiving device may further include the firmware updating unit which updates the firmware when the update request is received by the message processing unit.

Moreover, data used for the menu screen is periodically updated, and the data updating unit may periodically obtain the data used for the menu screen.

Moreover, the content receiving device may further include a display unit for displaying the content and the menu screen.

It is to be noted that these general and specific aspects may be implemented using a system, a method, an integrated circuit, a computer program, or a non-transitory computer-readable recording medium such as a compact disc read only memory (CD-ROM), or any combination of systems, apparatuses, methods, integrated circuits, computer programs, or recording media.

Hereinafter, details of a non-limiting embodiment are described with reference to the drawings. It is to be noted that detailed descriptions beyond necessity may be omitted. For example, details of well-known matter and overlapped descriptions for substantially the same configuration may be omitted. This is for preventing the following description from being unnecessarily lengthy and facilitating understanding of the person skilled in the art.

It is to be noted that the accompanying drawings and the following descriptions are provided by the inventor so that the person skilled in the art sufficiently understands the present disclosure, and are not intended to limit the scope of the subject matter in the Claims.

### Embodiment

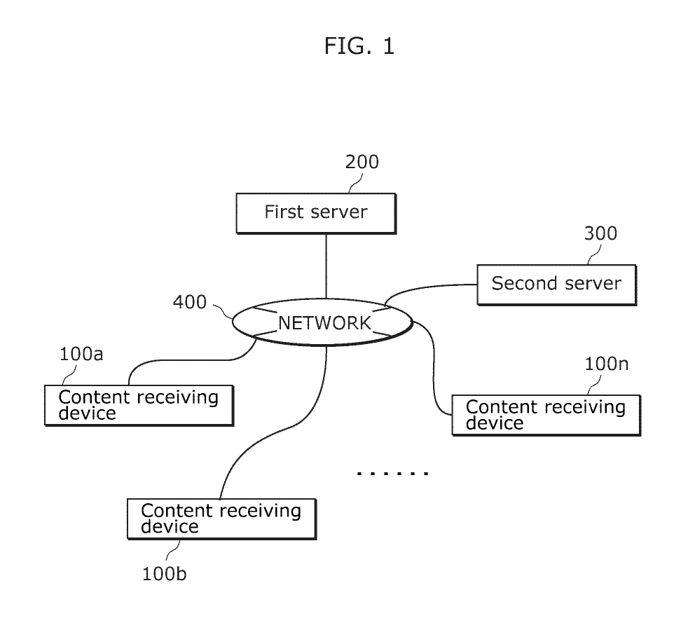

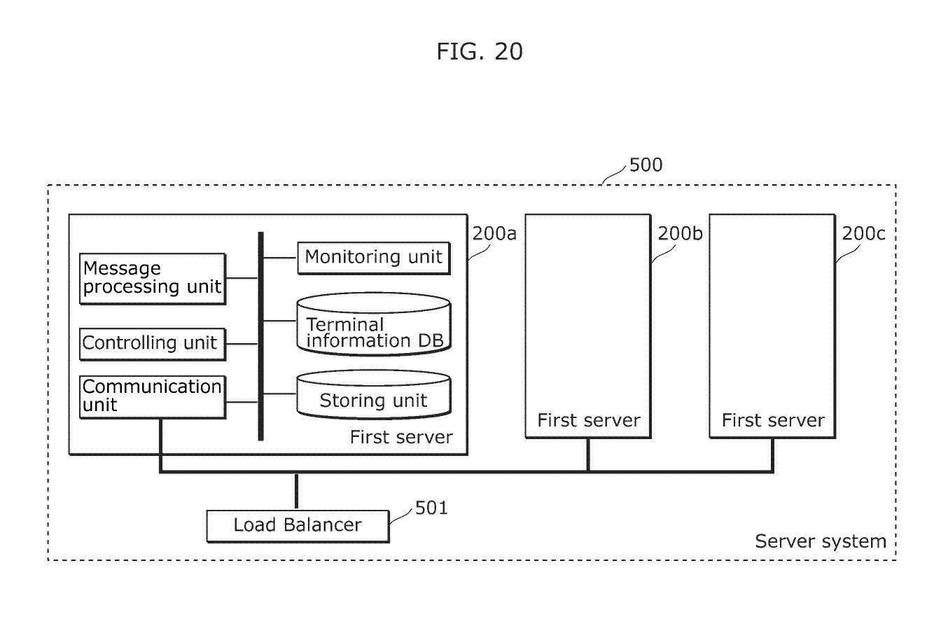

The following describes a non-limiting embodiment with reference to FIGS. 1 to 20.

FIG. 1 is a block diagram showing a schematic configuration of a content receiving system according to the embodiment.

The content receiving system includes a first server 200, a second server 300, and plural content receiving devices (terminal devices) 100a, 100b, to 100n as shown in FIG. 1. The content receiving devices 100a, 100b, to 100n are connected to the first server 200 and the second server 300 via a network 400.

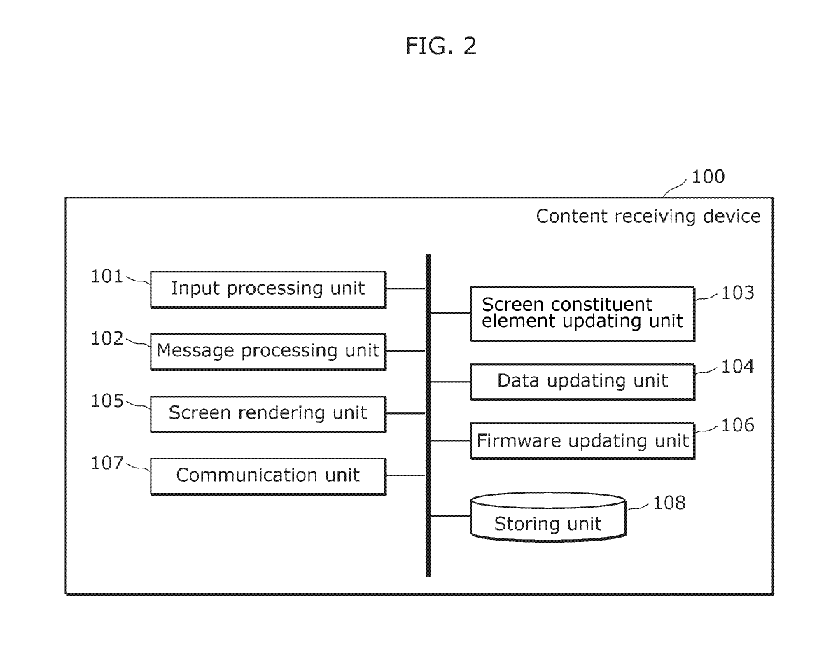

FIG. 2 is a block diagram showing a configuration of a content receiving device (terminal device) 100 according to the embodiment. Each of the content receiving devices 100a, 100b, to 100n shown in FIG. 1 corresponds to the content receiving device 100 shown in FIG. 2.

The content receiving device 100 receives content and displays a menu screen (launcher screen) in an updated state. The content receiving device 100 includes, as shown in FIG. 2, an input processing unit 101, a message processing unit 102, a screen constituent element updating unit 103, a data updating unit 104, a screen rendering unit 105, a firmware updating unit 106, a communication unit 107, and a storing unit 108.

The input processing unit 101 receives an input of an operation from a user, for example, through a remote controller, and performs processing according to the operation.

The message processing unit 102 receives a message (request) irrespective of whether the content receiving device 100 is in an active state or a non-active state (for example, a sleep state). For example, the message processing unit 102 receives an update request for updating a screen constituent element which is for displaying the menu screen. Moreover, the message processing unit 102 receives a deletion request for deleting a screen constituent element. Moreover, the message processing unit 102 receives an update request for updating firmware.

Upon receiving the update request from the message processing unit 102 in an active state or in a non-active state, the screen constituent element updating unit 103 deletes the screen constituent element stored in the storing unit 108 according to details of the update request. The screen constituent element updating unit 103 then obtains a new screen constituent element from the first server 200 and stores the obtained screen constituent element in the storing unit 108.

The data updating unit 104 periodically obtains data used in the menu screen which is displayed based on screen constituent elements. More specifically, the data updating unit 104 periodically obtains the data used in the menu screen irrespective of whether the content receiving device 100 is in an active state or a non-active state.

At a time when the content receiving device 100 starts up, the screen rendering unit 105 renders the menu screen using the screen constituent elements obtained in advance by the screen constituent element updating unit 103 and the data obtained in advance by the data updating unit 104

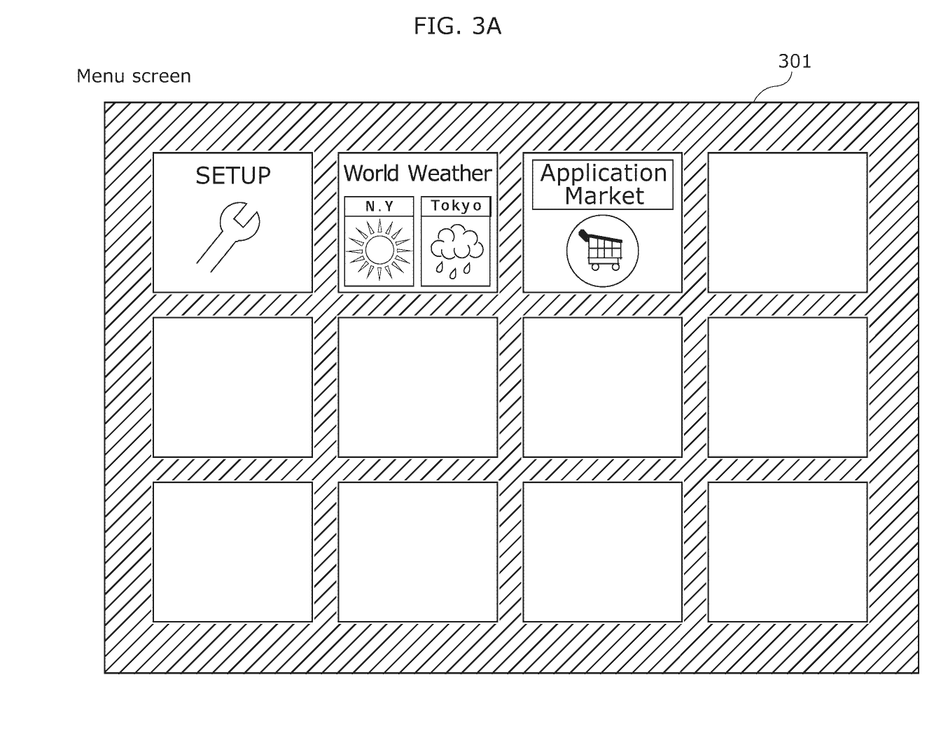

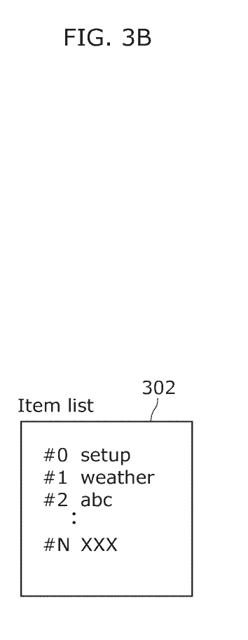

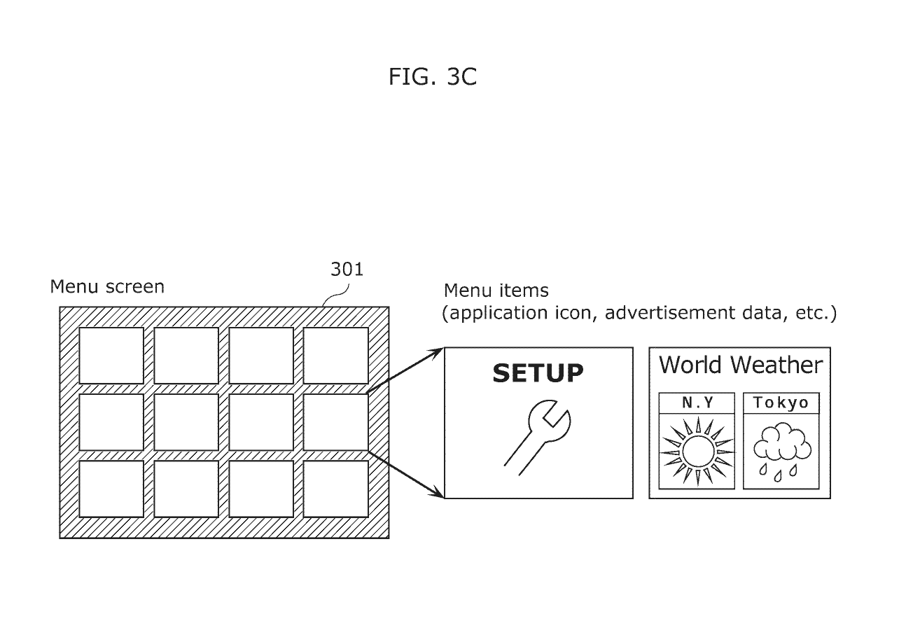

Here, a description is given of the menu screen. FIG. 3A is a diagram showing an example of the menu screen, FIG. 3B is a diagram showing an example of an item list of the menu screen, and FIG. 3C is a diagram for illustrating an example of menu items on the menu screen.

After the content receiving device 100 starts up, a menu screen 301 as shown in FIG. 3A is displayed by the screen rendering unit 105, for example. The menu screen 301 displays the menu items based on an item list 302 as shown in FIG. 3B. As shown in FIG. 3C, the menu items include, for example, an application icon and advertisement data; that is, more specifically, items such as “set up” and “weather”.

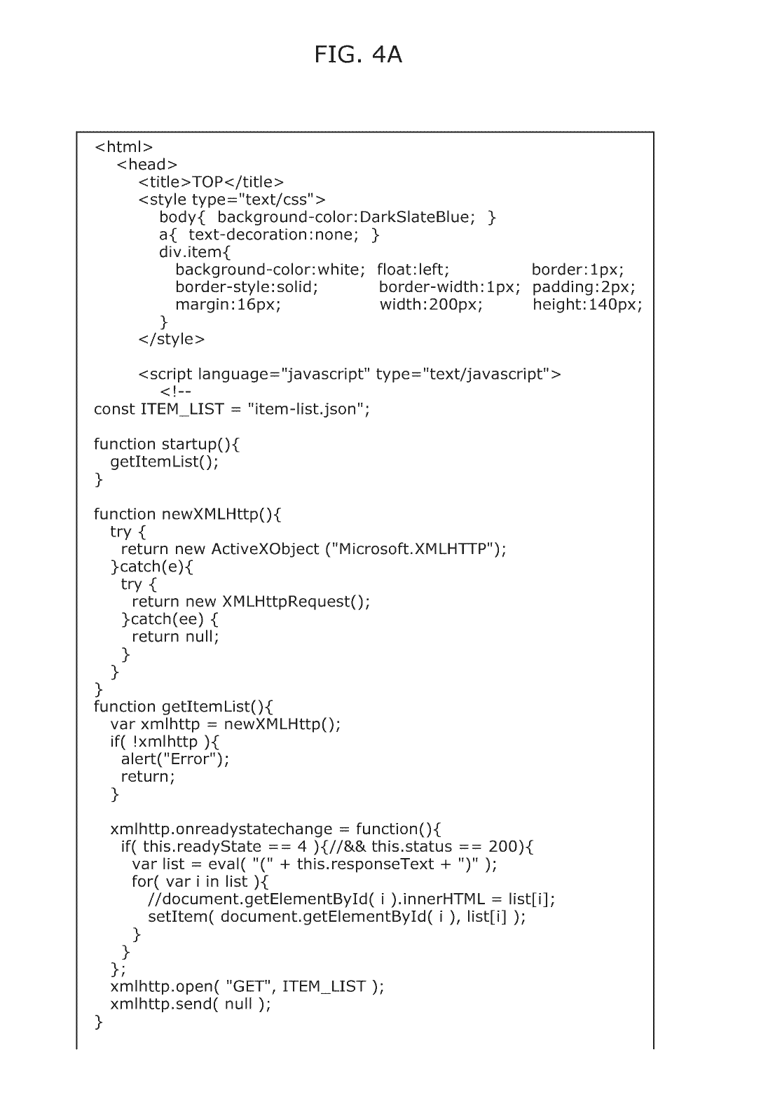

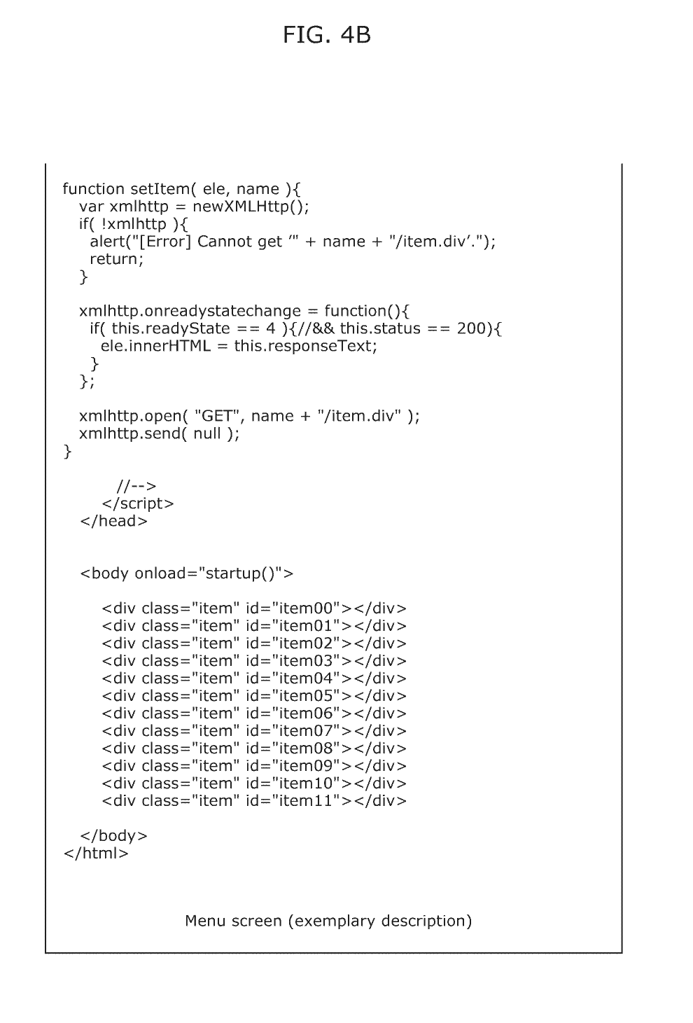

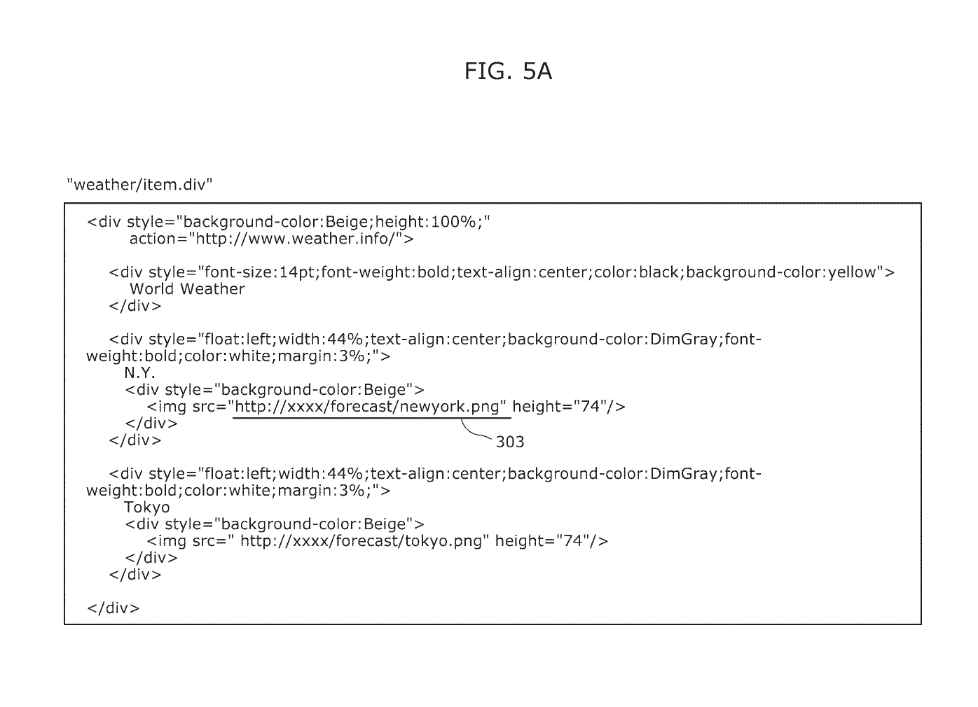

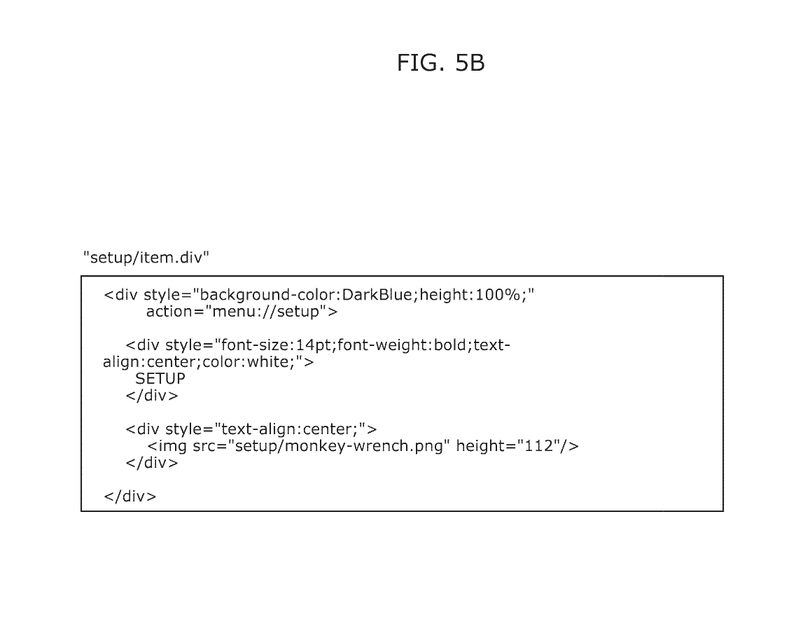

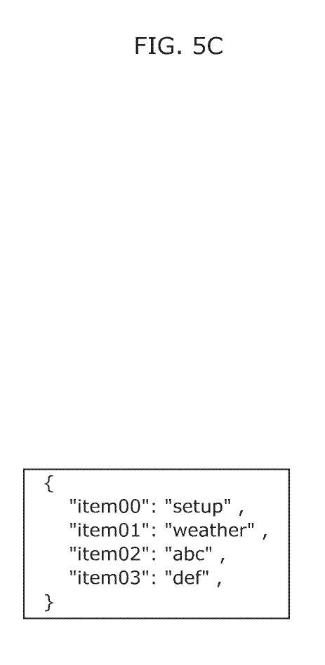

The screen rendering unit 105 renders the menu screen 301 according to a description of the menu items as shown in FIGS. 4A and 4B, a description of the menu items as shown in FIGS. 5A and 5B, and a description of the menu items as shown in FIG. 5C, for example.

Regarding a description of a menu item, for example, a description 303 which indicates that the data to be displayed as the menu item is obtained from the external network 400 may be present in the description of the menu item as shown in FIG. 5A. Data which is required to be obtained from the external network 400 is obtained by the data updating unit 104. Such data required to be obtained from the external network 400 includes data that is periodically updated such as data of weather or advertisement.

The firmware updating unit 106 updates the firmware when the screen constituent element obtained by the screen constituent element updating unit 103 indicates an update of the firmware (that is, when the obtained screen constituent element is a screen constituent element that prompts an update of the firmware). Moreover, the firmware updating unit 106 updates the firmware when the message processing unit 102 receives the update request for updating the firmware.

It is to be noted that the firmware means software as a whole. For example, the firmware may include a program for controlling the content receiving device 100. Moreover, the firmware may include the menu screen, the menu items, or other screen constituent elements.

The communication unit 107 is connected to the external network 400 via, for example, a local area network (LAN) such as Wi-Fi and Ethernet (registered trademark), and communicates with other devices including, for example, the first server 200 and the second server 300.

The storing unit 108 is, for example, a hard disk drive (HDD) or a memory, which stores therein the screen constituent elements obtained by the screen constituent element updating unit 103 and the data obtained by the data updating unit 104.

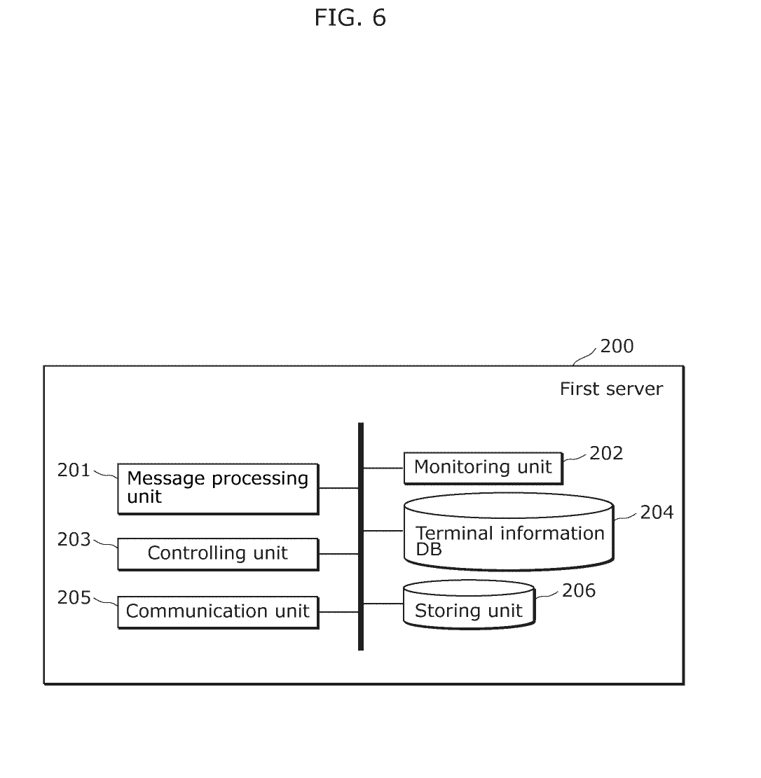

FIG. 6 is a block diagram showing a configuration of the first server 200 according to the embodiment.

The first server 200 is a server device (terminal managing server device) for distributing the screen constituent elements that are for displaying the menu screen to the content receiving device 100. The first server 200 includes, as shown in FIG. 6, a message processing unit 201, a monitoring unit 202, a controlling unit 203, a terminal information database (terminal information DB) 204, a communication unit 205, and a storing unit 206.

The message processing unit 201 is a processing unit (processor/controller) for transmitting a determined message to a determined terminal device and receiving a message from the terminal device. Here, the terminal device is the content receiving device 100 shown in FIG. 2, for example.

The monitoring unit 202 is a processing unit (processor/controller) for periodically monitoring details of the terminal information DB 204 and a state of the first server 200, and for determining contents of the message and timing to transmit the message.

The controlling unit 203 is a processing unit (processor/controller) for processing the message (for example, a request for transmitting the screen constituent elements or a request for transmitting a file used for updating the firmware received from the content receiving device 100) received by the message processing unit 201.

The terminal information DB 204 is a database (terminal information storing unit/storing unit/storage) which stores therein information indicating status of the content receiving device 100 connected via the network 400.

The communication unit 205 is a processing unit (processor/controller/interface) for communicating with other devices such as the content receiving device 100 via the network 400.

The storing unit 206 is a storing unit (data storing unit/storage) which stores therein the screen constituent elements for displaying the menu screen in the content receiving device 100, a file used for updating the firmware of the content receiving device 100, and others.

The second server 300 is a server device (content distribution server device) for distributing content for viewing. The content receiving device 100 obtains the content for viewing from the second server 300. It is to be noted that although a hyper text transfer protocol (HTTP) may be used for dividing data and obtaining the content for viewing, a method for obtaining the content for viewing is not particularly specified in this embodiment.

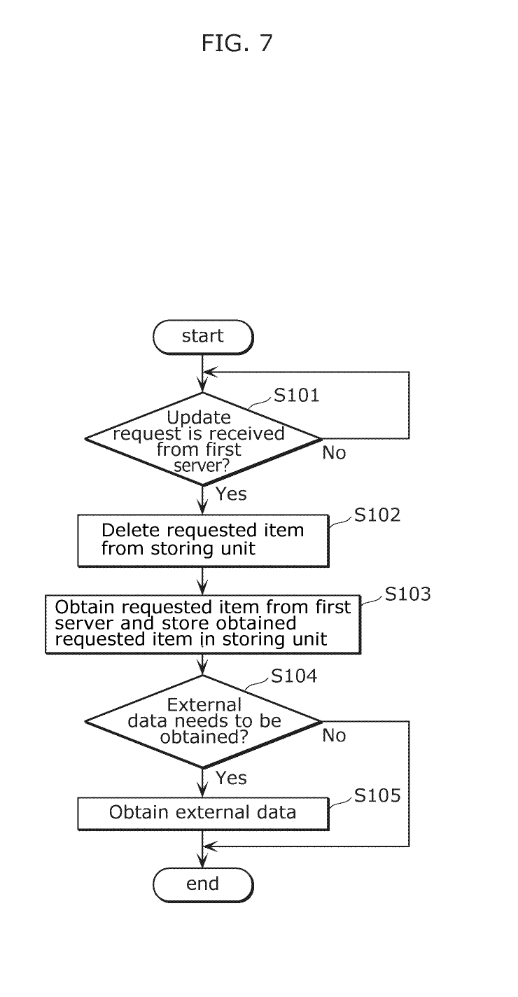

The following describes operations for updating the screen constituent element in the content receiving device 100 configured as above. FIG. 7 is a flowchart showing the operations for updating the screen constituent element in the content receiving device 100. Here, a description is given assuming that the content receiving device 100 is in a sleep state.

The message processing unit 102 determines whether or not the update request for updating the screen constituent element is received from the first server 200 (Step S101). When the update request is not received (No in Step S101), the message processing unit 102 repeats the determination process.

On the other hand, when the update request is received (Yes in Step S101), the message processing unit 102 informs the screen constituent element updating unit 103 of the reception of the update request for updating the screen constituent element. The screen constituent element updating unit 103 deletes the screen constituent element stored in the storing unit 108 according to the details of the update request. That is, the screen constituent element updating unit 103 deletes a description and data related to the menu item (screen constituent element) which requires updating according to the update request among the plural screen constituent elements stored in the storing unit 108 (Step S102).

Next, the screen constituent element updating unit 103 obtains, from the first server 200, a description and data related to the menu item which requires updating according to the update request and stores the obtained description and the data in the storing unit 108 (Step S103). Next, the data updating unit 104 determines whether or not the data required to be obtained from the external network 400 is present in the data displayed as the menu items (Step S104).

When the data required to be obtained from the external network 400 is present (Yes in Step S104) as a result of the determination, the data updating unit 104 obtains the data from the external network 400 (Step S105). It is to be noted that the data updating unit 104 periodically obtains the data when the data required to be obtained from the external network 400 is present. On the other hand, when the data required to be obtained from the external network 400 is not present (No in Step S104), the content receiving device 100 finishes the processing.

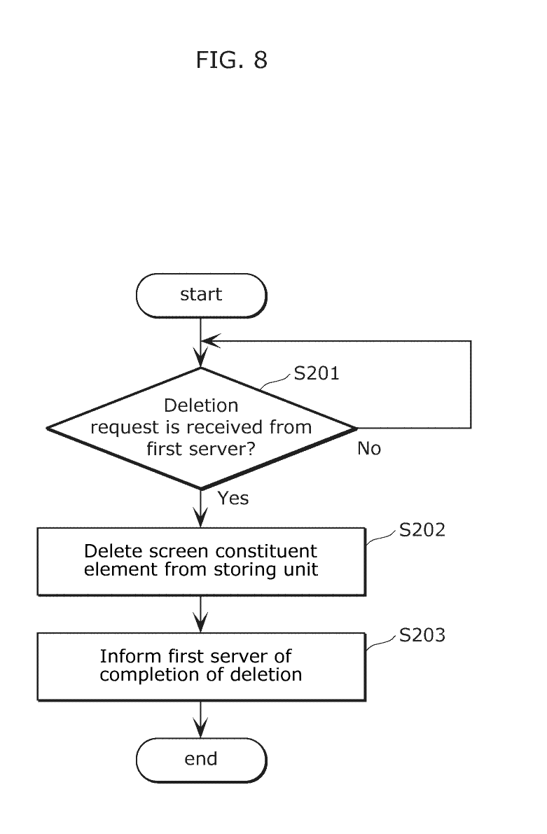

The following describes the operations for deleting the screen constituent element in the content receiving device 100. FIG. 8 is a flowchart showing the operations for deleting the screen constituent element in the content receiving device 100. It is to be noted that the deletion request for deleting the screen constituent element is transmitted from the first server 200 when an update of the firmware is required in the content receiving device 100. Moreover, a description is given also assuming that the content receiving device 100 is in a sleep state.

The message processing unit 102 determines whether or not the deletion request for deleting the screen constituent element is received from the first server 200 (Step S201). Here, when the deletion request is not received (No in Step S201), the message processing unit 102 repeats the determination process.

On the other hand, when the deletion request is received (Yes in Step S201), the message processing unit 102 informs the screen constituent element updating unit 103 of the reception of the deletion request for deleting the screen constituent element. The screen constituent element updating unit 103 deletes the screen constituent element stored in the storing unit 108 (Step S202). Next, the screen constituent element updating unit 103 informs the first server 200 via the communication unit 107 of the completion of the deletion of the screen constituent element (Step S203).

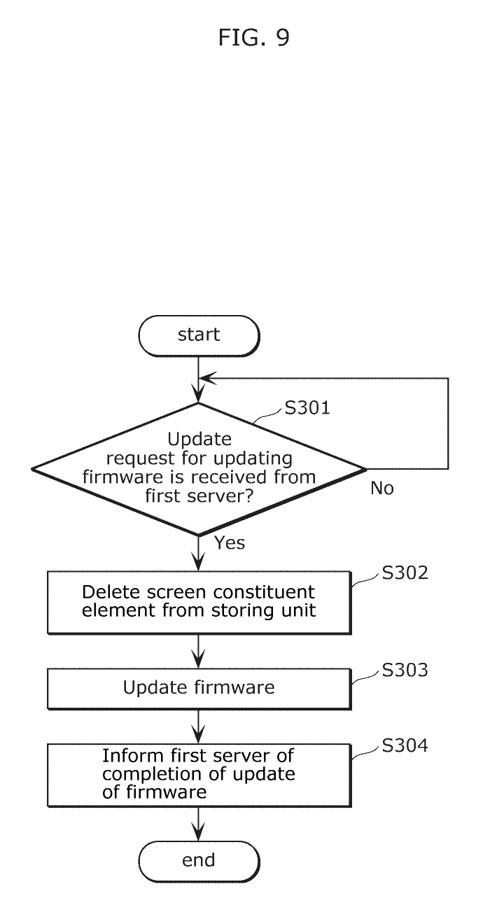

The following describes operations for updating the firmware of the content receiving device 100. FIG. 9 is a flowchart showing the operations for updating the firmware of the content receiving device 100. Here, a description is given also assuming that the content receiving device 100 is in a sleep state.

The message processing unit 102 determines whether or not the update request for updating the firmware is received from the first server 200 (Step S301). Here, when the update request for updating the firmware is not received (No in Step S301), the message processing unit 102 repeats the determination process.

On the other hand, when the update request for updating the firmware is received (Yes in Step S301), the message processing unit 102 informs the screen constituent element updating unit 103 of the reception of the update request for updating the firmware. The screen constituent element updating unit 103 deletes the screen constituent element stored in the storing unit 108 (Step S302). With this, the firmware can be updated later even if any trouble occurs during the update processing of the firmware.

Next, the firmware updating unit 106 updates the firmware (Step S303). When the update of the firmware is completed, the firmware updating unit 106 informs the first server 200 of the completion of the update of the firmware via the communication unit 107 (Step S304).

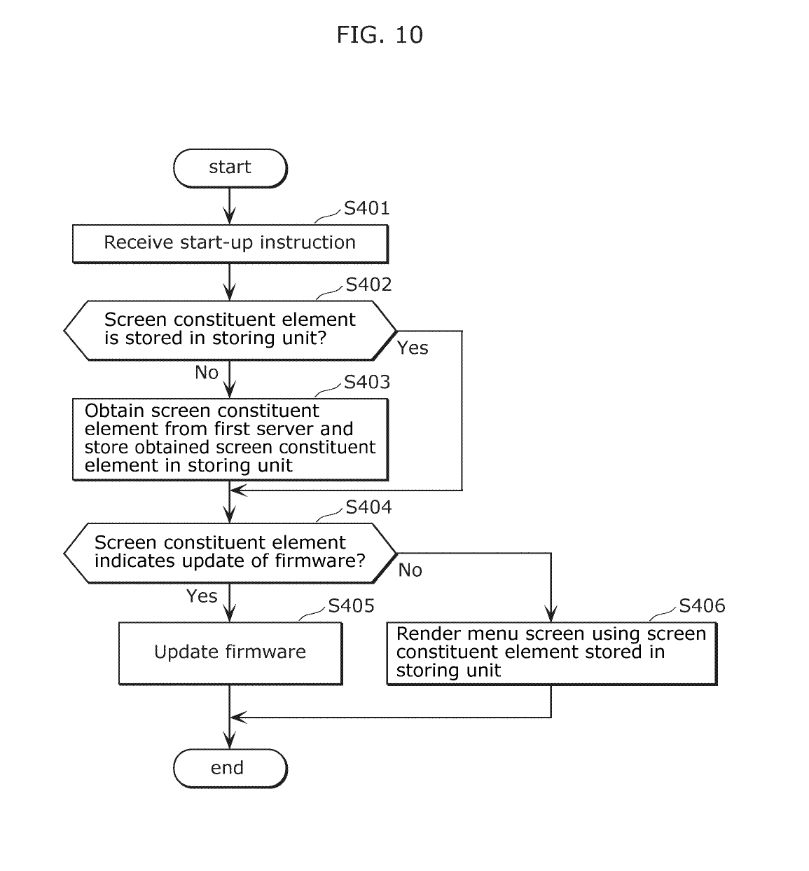

The following describes operations of the content receiving device 100 in starting up. FIG. 10 is a flowchart showing operations of the content receiving device 100 in starting up.

When the user inputs a start-up instruction to the content receiving device 100, the input processing unit 100 receives the start-up instruction and informs the screen rendering unit 105 of the reception of the start-up instruction (Step S401). The screen rendering unit 105 determines whether or not the screen constituent element obtained in advance by the screen constituent element updating unit 103 is stored in the storing unit 108 (Step S402).

When the screen constituent element is not stored in the storing unit 108 (No in Step S402) as a result of the determination, the screen constituent element updating unit 103 obtains the screen constituent element from the first server 200 and stores the obtained screen constituent element in the storing unit 108 (Step S403). On the other hand, when the screen constituent element is stored in the storing unit 108 (Yes in Step S402), processing for the obtainment is not performed.

Next, the screen rendering unit 105 determines whether or not the screen constituent element stored in the storing unit 108 indicates an update of the firmware (Step S404). When the screen constituent element indicates an update of the firmware (Yes in Step S404) as a result of the determination, the firmware updating unit 106 updates the firmware (Step S405).

On the other hand, when the screen constituent element does not indicate an update of the firmware (No in Step S404), the screen rendering unit 105 renders the menu screen. At this time, the screen rendering unit 105 uses the screen constituent element obtained in advance by the screen constituent element updating unit 103 and the data obtained in advance by the data updating unit 104 (Step S406).

As described above, the screen constituent element updating unit 103 obtains the screen constituent element in response to the update request for updating the screen constituent element from the first server 200 even when the content receiving device 100 is in a sleep state.

Furthermore, when data required to be obtained from the external network 400 is present in the data displayed as the menu items, the data updating unit 104 obtains the data. At a time when the content receiving device 100 starts up, the screen rendering unit 105 renders the menu screen using the screen constituent elements obtained in advance by the screen constituent element updating unit 103 and the data obtained in advance by the data updating unit 104.

With this, the content receiving device 100 can shorten the time taken for displaying the menu screen in an updated state when starting up.

Moreover, when receiving the deletion request for deleting the screen constituent element from the first server 200 while the content receiving device 100 is in a sleep state, the content receiving device 100 obtains the screen constituent element when starting up to update the firmware. On the other hand, when receiving the update request for updating the firmware from the first server 200 while the content receiving device 100 is in the sleep state, the content receiving device 100 immediately updates the firmware.

Accordingly, in the update of the firmware, it is also possible to change timing to update the firmware according to the request from the first server 200.

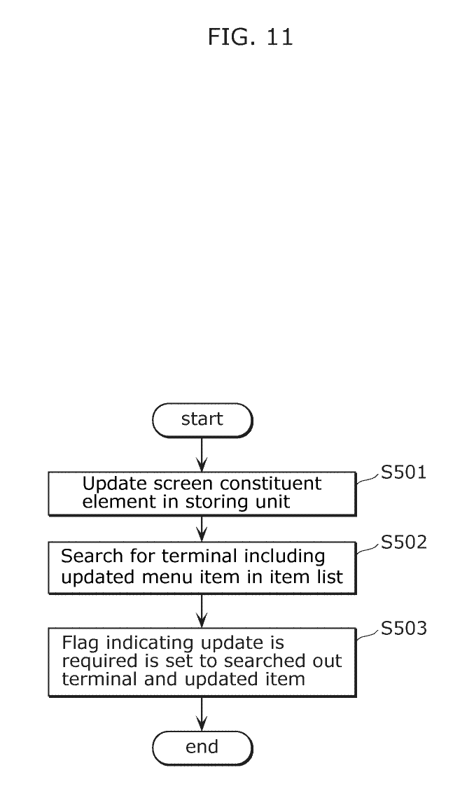

The following describes operations of the first server 200 configured as above. FIG. 11 is a flowchart showing operations of the first server 200 when the screen constituent element is updated.

The controlling unit 203 updates a menu item which is the screen constituent element stored in the storing unit 206 (Step S501). The controlling unit 203 searches the terminal information DB 204 for a terminal device that includes the updated menu item in the item list on the menu screen (Step S502). The controlling unit 203 sets, to the searched out terminal device and the updated menu item, a flag indicating an update is required (Step S503).

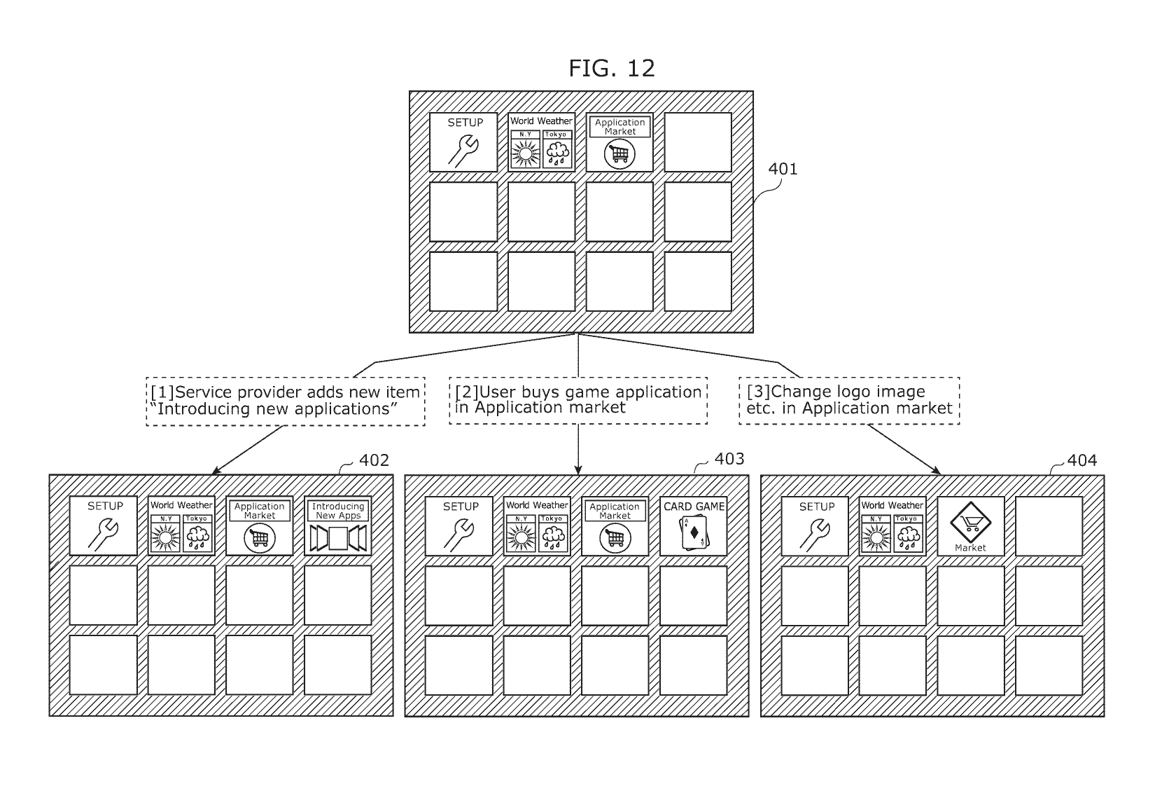

The following describes an illustrative example of the update of the screen constituent element. FIG. 12 shows an illustrative example of the update of the screen constituent element.

As shown in FIG. 12, there may be a case where a current menu screen 401 is changed to a menu screen 402, a menu screen 403, or a menu screen 404.

For example, there may be a case where a new service is added and thus a new menu item is added to all terminal devices of a target model as shown in the menu screen 402. Moreover, for example, there may be a case where the number of menu items changes according to an operation by the user buying an application as shown in the menu screen 403. Moreover, for example, there may be a case where the menu item itself is updated as shown in the menu screen 404.

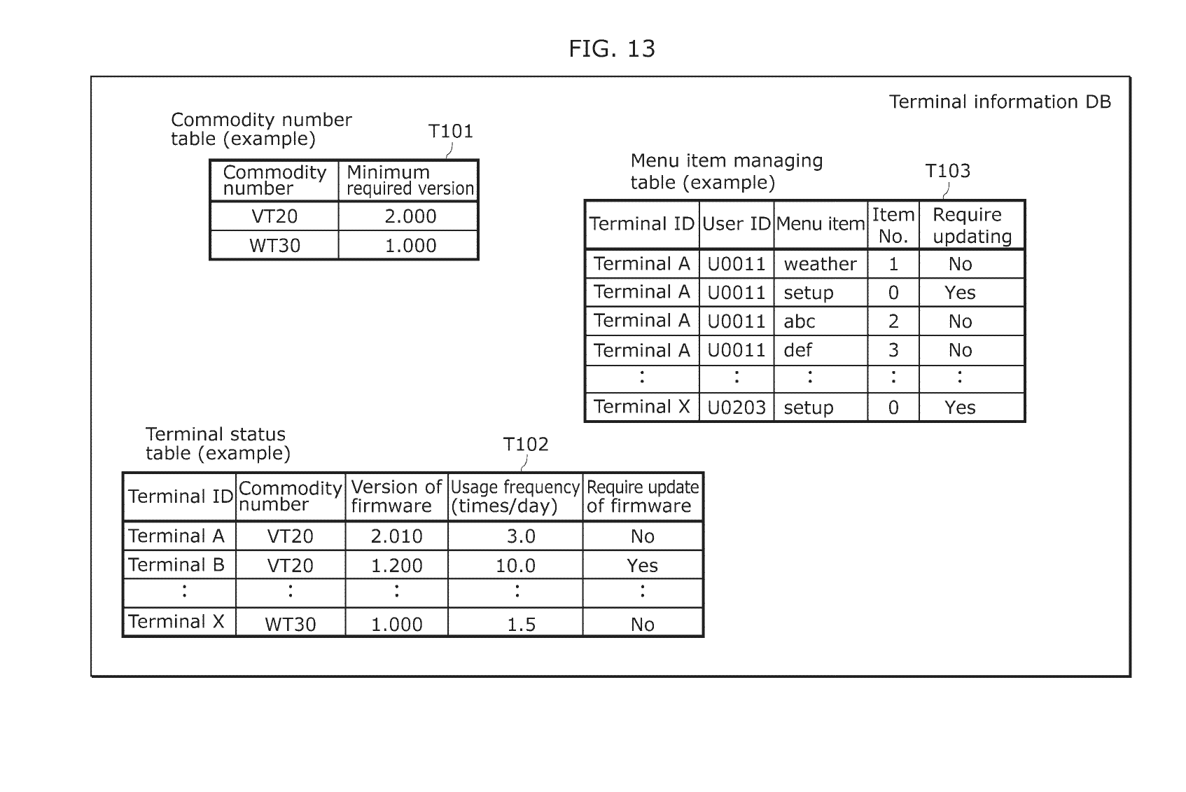

FIG. 13 shows an example of the terminal information DB 204. In this example, a commodity number table T101, a terminal status table T102, and a menu item managing table T103 are stored in the terminal information DB 204.

Moreover, in this example, the commodity number table T101 includes information indicating a commodity number and a minimum required version of the firmware. The terminal status table T102 includes information indicating a terminal ID, the commodity number of the terminal device, a version of the firmware of the terminal device, a usage frequency, and whether or not the firmware requires updating. The menu item managing table T103 includes information indicating the terminal ID, a user ID, a menu item, an item number, and whether or not the menu item requires updating.

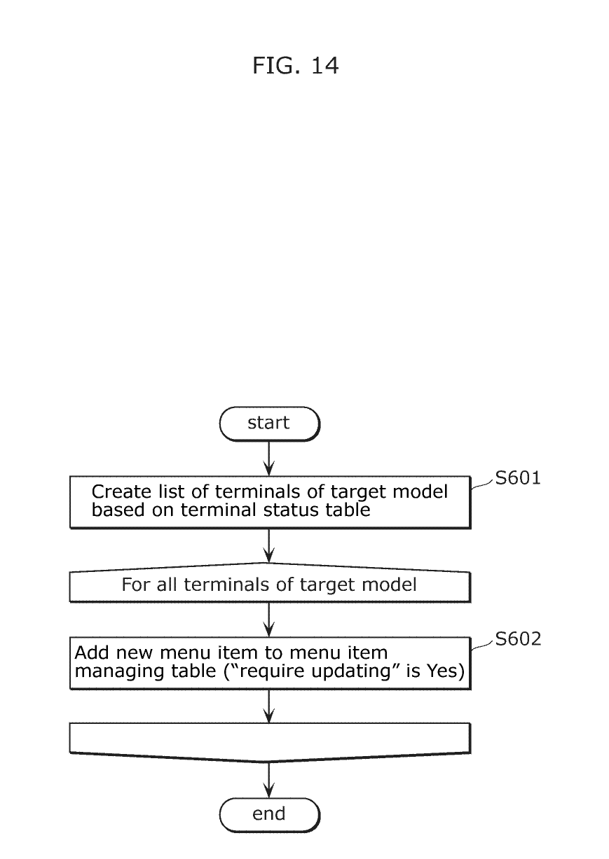

FIG. 14 is a flowchart showing operations when a new menu item is added to all terminal devices of the target model.

The controlling unit 203 searches the terminal status table T102 for terminal devices of the target model to which the new menu item is added, and creates a list of the terminal devices of the target model (Step S601). Next, the controlling unit 203 searches the menu item managing table T103 for an available item number for the target model, and adds the new menu item (a row corresponding to the menu item) (Step S602). At this time, a “require updating” field for the new menu item (in the row corresponding to the menu item) indicates “Yes”.

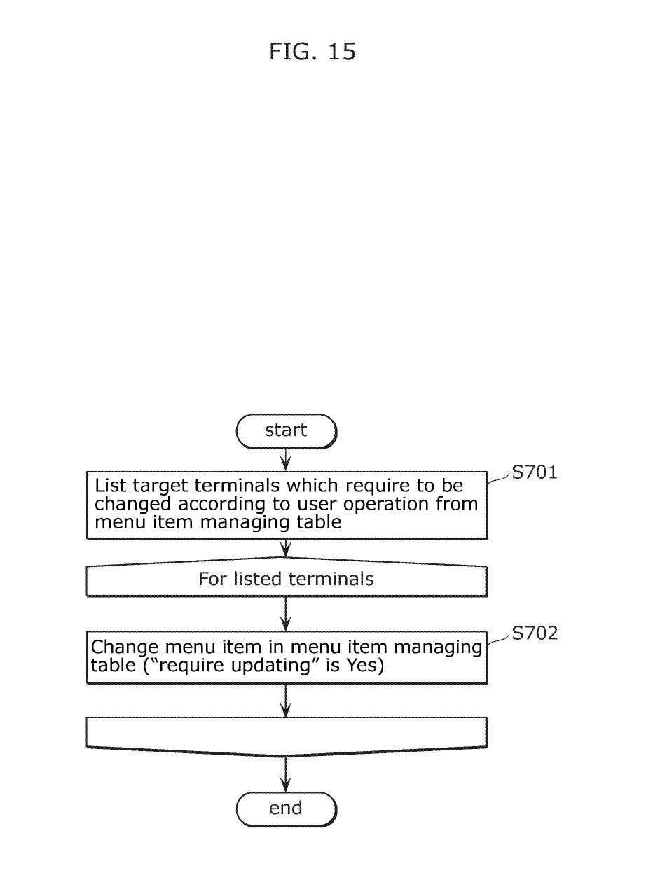

FIG. 15 is a flowchart showing operations when the number of menu items is changed according to an operation by a user.

The controlling unit 203 searches the menu item managing table T103 for target terminals which require to be changed (for example, terminal devices having the same user ID), and lists the target terminals which require to be changed (Step S701). Next, the controlling unit 203 changes the menu item in the menu item managing table T103 with respect to the target terminals in the list (Step S702). At this time, the “require updating” field for the changed menu item (in the rows corresponding to the menu item) indicates “Yes”.

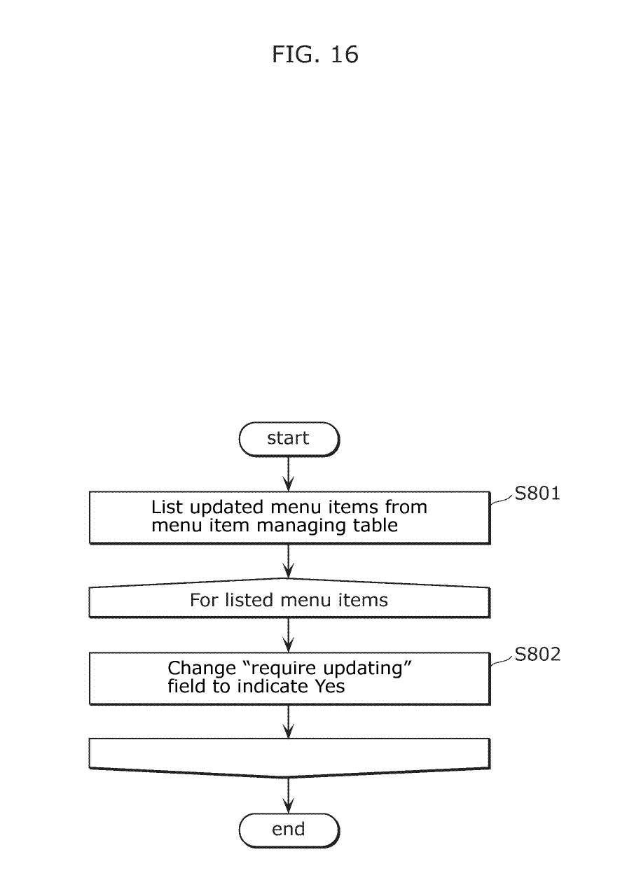

FIG. 16 is a flowchart showing operations when the menu items themselves are updated.

The controlling unit 203 searches the menu item managing table T103 for the updated menu items (rows corresponding to the menu items), and lists the updated menu items (Step S801). Next, the controlling unit 203 changes the “require updating” fields to indicate “Yes” with respect to all the menu items in the list (rows corresponding to the menu items) (Step S802).

The following describes the case where the firmware is updated.

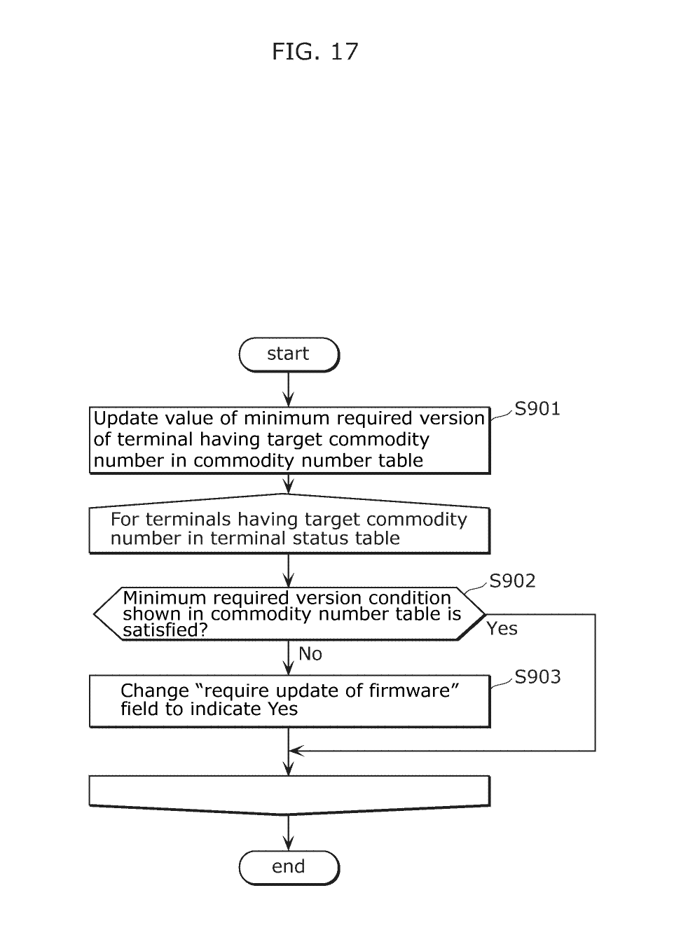

FIG. 17 is a flowchart showing operations when a minimum required version of the firmware is changed.

The controlling unit 203 updates a value of the minimum required version corresponding to the target commodity number in the commodity number table T101 (Step S901). The controlling unit 203 determines whether or not the version of a current firmware of the terminal device corresponding to the target commodity number in the terminal status table T102 satisfies a minimum required version condition corresponding to the target commodity number in the commodity number table T101 (Step S902).

When the version of the current firmware does not satisfy the minimum required version condition (No in Step S902), the controlling unit 203 changes the “firmware requires updating” field in the terminal status table T102 to indicate “Yes” (Step S903). On the other hand, when the version of the current firmware satisfies the minimum required version condition (Yes in Step S902), no particular processing is performed.

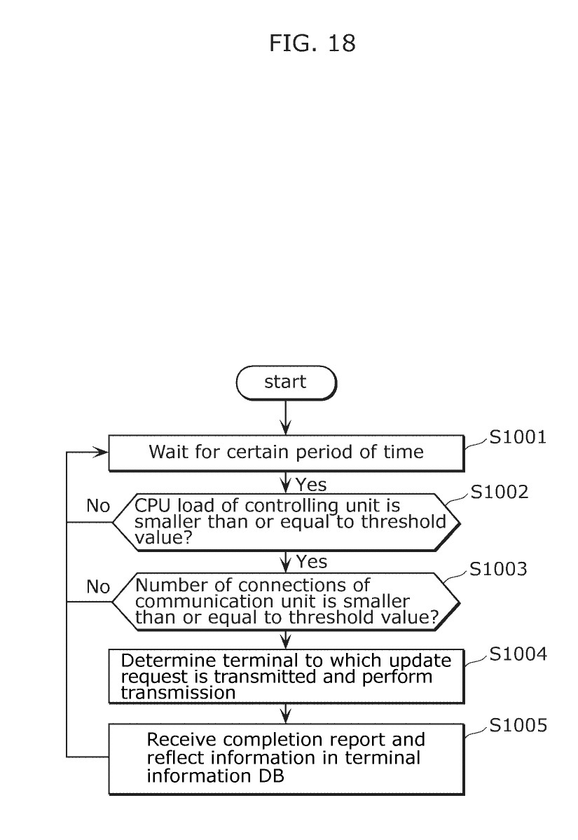

The following describes operations of the first server 200 in transmitting a message (request) to the content receiving device 100. FIG. 18 is a flowchart showing operations of the first server 200 in transmitting a message (request) to the content receiving device 100.

The monitoring unit 202 stands by for a predetermined period of time (Step S1001). The monitoring unit 202 determines whether or not a load (for example, a CPU load) of the controlling unit 203 is smaller than or equal to a predetermined threshold value (Step S1002). When the load of the controlling unit 203 is smaller than or equal to the predetermined threshold value (Yes in Step S1002), the monitoring unit 202 determines whether or not the number of connections of the communication unit 205 is smaller than or equal to a predetermined threshold value (Step S1003).

When the load of the controlling unit 203 is not smaller than or equal to the predetermined threshold value (No in Step S1002) or when the number of connections of the communication unit 205 is not smaller than or equal to the predetermined threshold value (No in Step S1003), the monitoring unit 202 stands by for the predetermined period of time (the process returns to Step S1001).

On the other hand, when the load of the controlling unit 203 is smaller than or equal to the predetermined threshold value (Yes in Step S1002) and the number of connections of the communication unit 205 is smaller than or equal to the predetermined threshold value (Yes in Step S1003), the monitoring unit 202 transmits a request to the terminal device. More specifically, the monitoring unit 202 determines a terminal device to which the update request for updating the screen constituent element, the deletion request for deleting the screen constituent element, or the update request for updating the firmware is transmitted, and transmits the request to the determined terminal device (Step S1004).

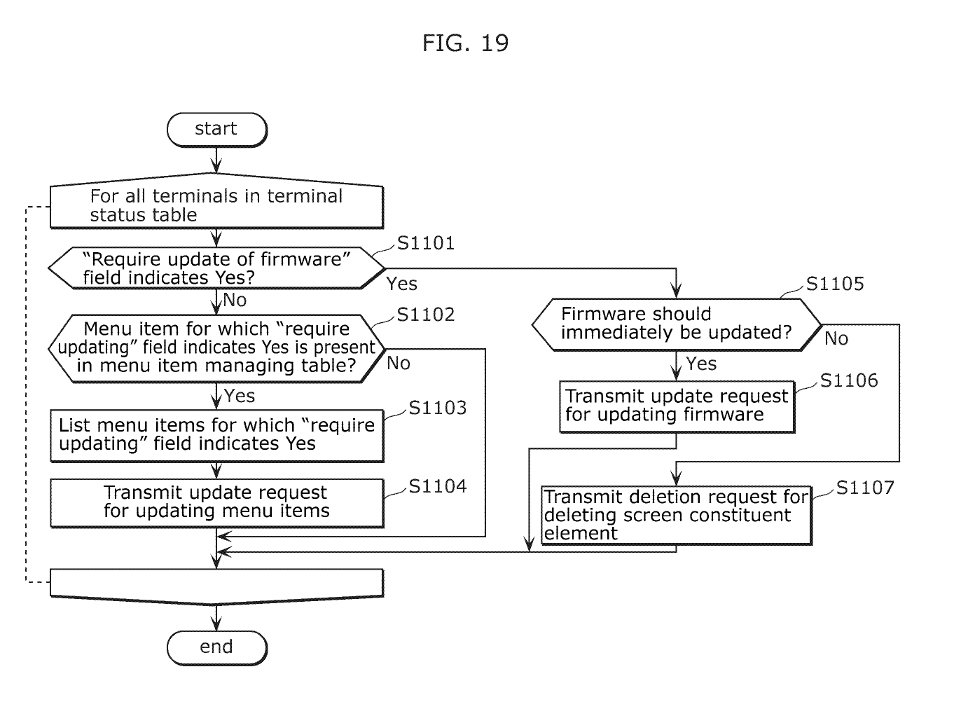

It is to be noted that the determination and the transmission is described with reference to FIG. 19 later. Next, the controlling unit 203 receives a completion report according to respective requests from the terminal device, and reflects the information in the report in the terminal information DB 204 (Step S1005).

FIG. 19 is a flowchart showing operations for the determination and the transmission in Step S1004 in FIG. 18.

The monitoring unit 202 determines whether or not the “firmware requires updating” field indicates “Yes” with respect to all of the terminal devices listed in the terminal status table T102 (Step S1101).

When it is determined the “firmware requires updating” field does not indicate “Yes” (No in Step S1101), the monitoring unit 202 determines whether or not a menu item for which “require updating” field in the menu item managing table T103 indicates “Yes” is present (Step S1102).

When a menu item for which “require updating” field indicates “Yes” is present (Yes in Step S1102), the monitoring unit 202 lists menu items for which “require updating” fields indicate “Yes” (Step S1103). The monitoring unit 202 instructs the message processing unit 201 to transmit the update request for updating the menu items listed (Step S1104). On the other hand, when a menu item for which “require updating” field indicates “Yes” is not present (No in Step S1102), the monitoring unit 202 finishes the processing.

Moreover, when it is determined the “firmware requires updating” field indicates “Yes” (Yes in Step S1101), the monitoring unit 202 determines whether or not the firmware should immediately be updated (Step S1105).

When it is determined the firmware should immediately be updated (Yes in Step S1105), the monitoring unit 202 instructs the message processing unit 201 to transmit the update request for updating the firmware (Step S1106). On the other hand, when it is determined the firmware should not immediately be updated (No in Step S1105), the monitoring unit 202 instructs the message processing unit 201 to transmit the deletion request for deleting the screen constituent element (Step S1107).

It is to be noted that the determination of whether or not the firmware should immediately be updated is enabled by, for example, storing a flag to the terminal status table T102 and others.

Moreover, although processing is performed in all terminal devices listed in the terminal status table T102 here, the processing is not necessarily performed in all of the terminal devices. The range in which the processing is performed may be limited by information such as the number of terminal devices and the usage frequency in the terminal status table T102.

As described above, after first server 200 updates the screen constituent element, the first server 200 requests the content receiving device 100 to update the screen constituent element.

With this, the content receiving device 100 can obtain the screen constituent element in advance, and shorten the time taken for displaying the menu screen in an updated state when starting up.

Moreover, the first server 200 determines the terminal device to which the update request for updating the screen constituent element, the deletion request for deleting the screen constituent element, or the update request for updating the firmware is transmitted according to a state of a load of the first server 200, for example, and transmits a request to the determined terminal device. With this, it is possible to distribute the load of the first server 200.

It is to be noted that although the first server 200 includes one device as shown in FIG. 6 in this embodiment, the configuration is not limited to this. For example, the first server 200 may be a server system 500 including plural first servers 200a, 200b, and 200c, and a load balancer 501. The load balancer 501 is accessed by the terminal device and assigns processing to plural first servers 200a, 200b, and 200c in the server system 500.

In this case, in the flowchart shown in FIG. 18, it may be determined whether or not a network bandwidth of the load balancer 501 is less than or equal to a predetermined threshold value, and whether or not the number of connections between the controlling unit 203 and the terminal information DB 204 is less than or equal to a predetermined threshold value, in addition to the determination of whether or not the load of the controlling unit 203 and the number of connections of the communication unit 205 are less than or equal to the predetermined threshold values.

Moreover, in this embodiment, the content receiving device 100 does not have a display unit (display device) such as a display, and the screen rendering unit 100 renders the menu screen on a display unit (display device) connected to the content receiving device 100. However, the configuration of the content receiving device 100 is not limited to this. For example, the content receiving device 100 may have a display unit (display device) such as a display.

Moreover, as described above, the firmware may include the menu items. Therefore, the update request for updating the menu item is interpreted as an example of the update request for updating the firmware. Accordingly, as in the example shown in FIG. 19, the first server 200 may transmit the update request for updating the firmware (menu item) even when the version of the firmware satisfies the minimum required version condition.

When receiving the update request for updating the menu items while the content receiving device 100 is in a sleep state, the content receiving device 100 updates the menu item in the sleep state. That is, the first server 200 transmits the update request for updating the menu item as the update request for immediately updating the firmware, by which the firmware is immediately updated. With this, detailed updating of the firmware is immediately applied.

Moreover, in the example shown in FIG. 19, the first server 200 (monitoring unit 202) may determine whether or not the menu item should immediately be updated before transmitting the update request for updating the menu item. When it is determined the menu item should not immediately be updated, the first server 200 (message processing unit 201) may transmit the deletion request for deleting the screen constituent element instead of the update request for updating the menu item. With this, the first server 200 is capable of appropriately controlling the update timing.

Moreover, as in the example shown in FIG. 19, the first server 200 (monitoring unit 202) determines whether or not the firmware should immediately be updated in this embodiment. The first server 200 (monitoring unit 202) may determine whether or not the firmware should immediately be updated according to whether to perform a whole update or a partial update. The whole part of the firmware is updated in the whole update, and a part of the firmware is updated in the partial update.

As described above, the firmware may include the menu screen and the menu items, or other screen constituent elements. Therefore, only some menu items may be updated through the partial update of the firmware.

For example, since the whole update takes time, the whole update may be performed when the content receiving device 100 is in a sleep state. On the other hand, since the partial update does not take time, the partial update may be performed at the time when the content receiving device 100 starts up. Therefore, the first server 200 may determine the firmware should immediately be updated in the case of the whole update. In the case of the partial update, the first server 200 may determine the firmware should not immediately be updated.

Moreover, the first server 200 (monitoring unit 202) may determine whether or not the firmware should immediately be updated based on the amount of data to be updated, the amount of data to be transmitted/received, the amount of processing performed in the terminal device, or the amount of processing performed in the first server 200 in the update of the firmware.

For example, when the data amount as above is more than or equal to predetermined data amount, or the processing amount as above is more than or equal to predetermined processing amount, the first server 200 may determine the firmware should immediately be updated. With this, an update which takes time is performed in a sleep state.

Moreover, the first server 200 (monitoring unit 202) may determine whether or not the firmware should immediately be updated based on a state of the load of the first server 200. For example, it may be that when the load of the first server 200 is smaller than or equal to a predetermined load, the first server 200 determines the firmware should immediately be updated, and when the load of the first server 200 is larger than the predetermined load, the first server 200 determines the firmware should not immediately be updated. Moreover, the first server 200 may evaluate the load based on the number of connections with the terminal devices or the CPU load.

Moreover, the first server 200 (monitoring unit 202) may determine the number (ratio) of terminal devices for which it is determined the firmware should immediately be updated based on the state of the load of the first server 200. The first server 200 may then determine the firmware should immediately be updated only for the determined number (ratio) of terminal devices. With this, the load of the first server 200 is appropriately distributed.

Moreover, the first server 200 (monitoring unit 202) may determine whether or not the firmware should immediately be updated for each terminal device based on a usage frequency, referring to the terminal status table T102. For example, the first server 200 may determine the firmware should immediately be updated for a terminal device the usage frequency of which is more than or equal to a predetermined frequency, and determine the firmware should not immediately be updated for a terminal device the usage frequency of which is less than the predetermined frequency.

Moreover, the first server 200 (monitoring unit 202) may determine whether or not the firmware should immediately be updated based on a degree of importance of an update of the firmware. For example, the first server 200 may determine the firmware should immediately be updated when the update of the firmware corresponds to a modification of an existing function, and determine the firmware should not immediately be updated when the update of the firmware corresponds to an addition of a new function.

Moreover, the first server 200 (monitoring unit 202) may determine whether or not the firmware should immediately be updated based on a difference between a current version of the firmware of the terminal device and the minimum required version. For example, the first server 200 may determine the firmware should immediately be updated when the difference between the versions is larger than a predetermined threshold value.

The embodiment has been described above as an example of techniques in the present disclosure. For this purpose, the appended drawings and the detailed descriptions are provided.

Thus, the constituent elements described in the appended drawings and the detailed descriptions may include not only constituent elements essential to solve the technical problem but constituent elements that are inessential to solve the technical problem for the purpose of describing the above implementation. Therefore, the inessential constituent elements should not be regarded as essential only because the inessential constituent elements are described in the appended drawings and the detailed descriptions.

Moreover, since the above embodiment is for illustrating the technique in the present disclosure, various modifications, replacements, additions, omissions, and others are possible within the scope of the Claims and their equivalents.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to a terminal managing server device for appropriately managing a terminal device. Specifically, the present disclosure is applicable to a server or a cloud computing system for managing a television receiver, a set top box, an information terminal and others.

1. A terminal managing server device for managing a terminal device which receives content, the terminal managing server device comprising:
a storing unit which stores therein terminal information including information indicating a version of firmware of the terminal device; and
a processing unit configured to selectively transmit to the terminal device one of (i) a first update request for updating the firmware by a first updating method and (ii) a second update request for updating the firmware by a second updating method in which update timing is different from update timing in the first updating method, based on the terminal information stored in the storing unit.

2. The terminal managing server device according to claim 1,
wherein the processing unit is configured to selectively transmit to the terminal device one of (i) the first update request for immediately updating the firmware and (ii) the second update request for updating the firmware later.

3. The terminal managing server device according to claim 2,
wherein the processing unit is configured to determine whether or not the firmware should immediately be updated, and transmit the first update request when it is determined that the firmware should immediately be updated.

4. The terminal managing server device according to claim 1,
wherein the processing unit is configured to determine whether or not the version of the firmware satisfies a minimum version condition based on the terminal information, and selectively transmit one of the first update request and the second update request when it is determined that the version of the firmware does not satisfy the minimum version condition.

5. The terminal managing server device according to claim 4,
wherein the processing unit is configured to:
determine whether or not the firmware should immediately be updated when it is determined that the version of the firmware does not satisfy the minimum version condition; and
transmit the first update request from among (i) the first update request for immediately updating the firmware and (ii) the second update request for updating the firmware later, when it is determined that the firmware should immediately be updated.

6. The terminal managing server device according to claim 1,
wherein the processing unit is configured to selectively transmit to the terminal device one of (i) the first update request for updating the firmware of the terminal device in a sleep state while the terminal device is in the sleep state and (ii) the second update request for updating the firmware of the terminal device in the sleep state at a time after the terminal device resumes from the sleep state.

7. The terminal managing server device according to claim 1,
wherein the processing unit is configured to selectively transmit to the terminal device one of (i) the first update request for deleting data in the terminal device and updating the firmware of the terminal device in a sleep state while the terminal device is in the sleep state and (ii) the second update request for deleting the data in the terminal device in a sleep state while the terminal device is in the sleep state and updating the firmware at a time after the terminal device resumes from the sleep state.

8. The terminal managing server device according to claim 7,
wherein when transmitting the second update request, the processing unit is configured to transmit, as the second update request, a deletion request for deleting the data in the terminal device.

9. A terminal device which receives content, the terminal device comprising:
a message processing unit configured to receive one of (i) a first update request for updating firmware of the terminal device by a first updating method and (ii) a second update request for updating the firmware by a second updating method in which update timing is different from update timing in the first updating method; and
a firmware updating unit configured to update the firmware,
wherein the firmware updating unit is configured to:
update the firmware by the first updating method when the message processing unit receives the first update request; and
update the firmware by the second updating method when the message processing unit receives the second update request.

10. The terminal device according to claim 9,
wherein when the message processing unit receives the first update request while the terminal device is in a sleep state, the firmware updating unit is configured to update the firmware while the terminal device is in the sleep state, and
when the message processing unit receives the second update request while the terminal device is in the sleep state, the firmware updating unit is configured to update the firmware at a time after the terminal device resumes from the sleep state.

11. A terminal managing method for managing a terminal device which receives content, the method comprising
selectively transmitting to the terminal device one of (i) a first update request for updating firmware by a first updating method and (ii) a second update request for updating the firmware by a second updating method in which update timing is different from update timing in the first updating method, based on terminal information stored in a storing unit, the terminal information including information indicating a version of the firmware of the terminal device.
